(19) United States
(12) Patent Application Publication
(10) Pub. No.: US 2009/0303387 A1
(43) Pub. Date: Dec. 10, 2009

(54) DIGITAL TV HAVING TWO CHANNEL STEREO

(75) Inventors: TSUNG-CHUN CHEN, Tu-Cheng (TW); HER-CHING SHYU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/331,446

(22) Filed: Dec. 10, 2008

(30) Foreign Application Priority Data
Jun. 4, 2008 (CN) 200810301955.5

(51) Int. Cl. H04N 5/45; H04N 5/46; H04N 7/00

(52) U.S. Cl. 348/565; 348/729; 348/552; 348/E05.099

(57) ABSTRACT

A digital television (TV) having two channel stereo receives two sets of readable TV signals corresponding to two selected TV channels, filters the two sets of readable TV signals to obtain a first set of audio data and a second set of audio data first Bluetooth transmitter is configured for converting the first set of decoded audio data into a first analog audio signal, and a second Bluetooth transmitter is configured for converting the second set of decoded audio data into a second analog audio signal, so as to realize two channel stereo.

### BACKGROUND

1. Field of the Invention

Embodiments of the present disclosure relate to digital televisions (TVs), and particularly to digital TVs having two channel stereo.

2. Description of Related Art

With the coming of video/audio ages, image displaying methods and image processing technology are developing rapidly. TVs having picture in picture (PIP) technology is widely used for displaying two simultaneous images. PIP technology allows people to watch a plurality of channels easily or view different sections of a film simultaneously.

As shown in FIG. 1, one such PIP digital TV 1 includes an antenna 10, a tuner 11, a signal controller 12, and a PIP processor 13. The antenna 10, the tuner 11, the signal controller 12 and the PIP processor 13 are connected in series. The signal controller 12 converts digital TV signals into readable TV signals. The PIP processor 13 receives two sets of readable TV signals corresponding to two selected TV channels, obtains a first set of video data and a second set of video data by filtering the TV signals, and sends the first set of video data and the second set of video data to a video decoder 15 to obtain two sets of analog video signals. Further, the PIP processor 13 obtains a first set of audio data and a second set of audio data by filtering the TV signals, and sends the first set of audio data and the second set of audio data to an audio decoder 14. The audio decoder 14 decodes the first set of audio data and the second set of audio data into a first set of analog audio signals and a second set of analog audio signals. However, because there are only two speakers (not shown) in the digital TV 1, the two speakers output two different sets of analog audio signals at the same time, which would disturb users. Therefore, the digital TV 1 cannot provide two channel stereo.

What is needed, therefore, is a digital TV with two channel stereo to overcome the above-stated problems.

### BRIEF DESCRIPTION OF THE DRAWINGS

FIG. 1 is a block diagram of a digital TV including an audio decoder.

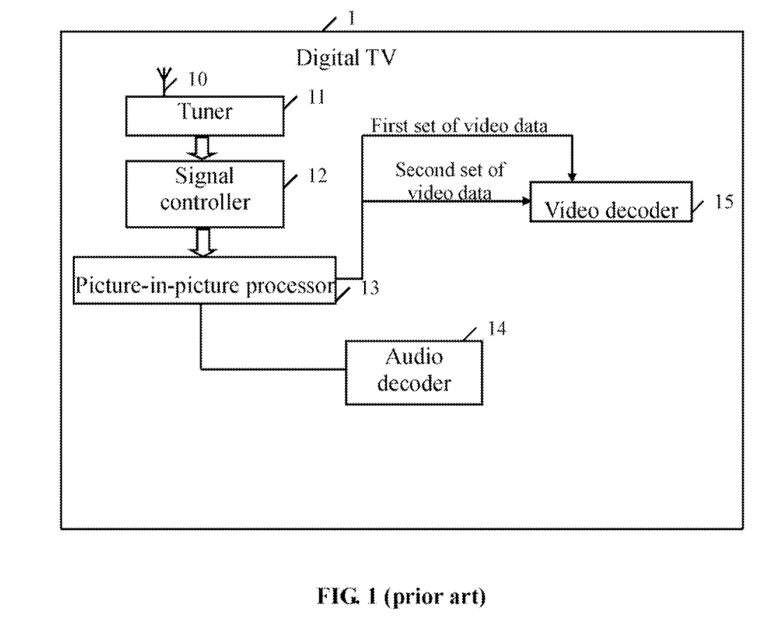

FIG. 2 is a block diagram of one embodiment of a digital TV having two channel stereo of the present embodiment.

### DETAILED DESCRIPTION OF CERTAIN INVENTIVE EMBODIMENTS

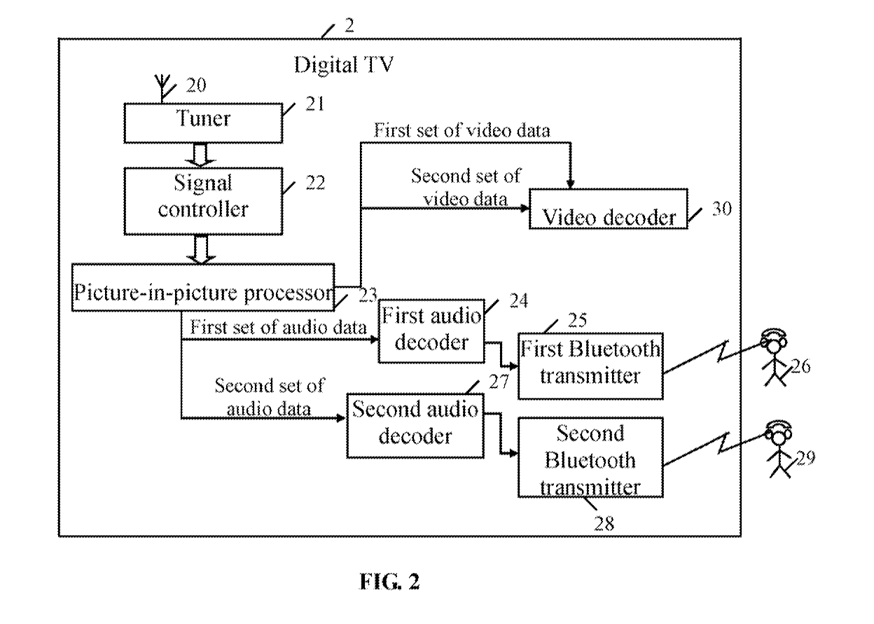

FIG. 2 is a block diagram of one embodiment of a digital TV 2 having two channel stereo of the present embodiment. The digital TV 2 includes an antenna 20, a tuner 21, a signal controller 22, a PIP processor 23, which are connected in series. The antenna 20 receives radio frequency (RF) signals broadcasted from one or more TV stations. The tuner 21 converts the RF signals into digital signals, and filters the digital signals into digital TV signals. The signal controller 30 is configured for converting the digital TV signals into readable TV signals which include audio signals and video signals. The PIP processor 23 is configured for receiving two sets of readable TV signals from the signal controller 30 corresponding to two selected TV channels, obtaining a first set of audio data and a second set of audio data by filtering the readable TV signals, sending the first set of audio data to a first audio decoder 24 and sending the second set of audio data to a second audio decoder 27.

The first audio decoder 24 is configured for decoding the first set of audio data and sending the first set of decoded audio data to a first Bluetooth transmitter 25. The first Bluetooth transmitter 25 converts the first set of decoded audio data into a first analog audio signal. A Bluetooth earphone 26 can be used to reproduce sound corresponding the first analog audio signal from the first Bluetooth transmitter 25.

The second audio decoder 27 decodes the second set of audio data and sends the second set of decoded audio data to a second Bluetooth transmitter 28. The second Bluetooth transmitter 28 converts the second set of decoded audio data into a second analog audio signal. A Bluetooth earphone 29 can be used to reproduce sound corresponding the second analog audio signal from the second Bluetooth transmitter 28.

The digital TV 2 can obtain two channel stereo corresponding to two selected TV channels by using the first audio decoder 24, the second audio decoder 27, the first Bluetooth transmitter 25, and the second Bluetooth transmitter 28.

The digital TV 2 further includes a video decoder 30. The video decoder 30 is configured for filtering a first set of video data and a second set of video data sent from the PIP processor 23 to obtain two sets of analog video signals.

By using the first audio decoder 24, the first Bluetooth transmitter 25 and the Bluetooth earphone 26, a user may hear a first stereophonic sound corresponding to a first selected TV channel. At the same time, other user may hear a second stereophonic sound corresponding to a second selected TV channel by using the second audio decoder 27, the second Bluetooth transmitter 28 and the Bluetooth earphone 29. Thus, digital TV 2 realizes two channel stereo.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A digital television (TV) having two channel stereo, the digital TV comprising a picture-in-picture (PIP) processor, a first audio decoder, a second audio decoder, a first Bluetooth transmitter and a second Bluetooth transmitter, wherein:
the PIP processor is configured for receiving two sets of readable TV signals corresponding to two selected TV channels, filtering the two sets of readable TV signals to obtain a first set of audio data and a second set of audio data, sending the first set of audio data to the first audio decoder and sending the second set of audio data to the second audio decoder;
the first audio decoder is configured for decoding the first set of audio data and sending the first set of decoded audio data to the first Bluetooth transmitter;
the second audio decoder is configured for decoding the second set of audio data and sending the second set of decoded audio data to the second Bluetooth transmitter;
the first Bluetooth transmitter is configured for converting the first set of decoded audio data into a first analog audio signal, and the second Bluetooth transmitter is configured for converting the second set of decoded audio data into a second analog audio signal, so as to realize two channel stereo.

2. The digital TV as claimed in claim 1, wherein the PIP processor is further configured for obtaining a first set of video data and a second set of audio data by filtering the two sets of readable TV signals.

3. The digital TV as claimed in claim 2, further comprising a video decoder configured for decoding the first set of video data and the second set of video data to obtain two analog video signals.

4. The digital TV as claimed in claim 1, further comprising an antenna configured for receiving radio frequency signals.

5. The digital TV as claimed in claim 4, further comprising a tuner configured for converting the radio frequency signals into digital signals, and obtaining digital TV signals by filtering the digital signals.

6. The digital TV as claimed in claim 5, further comprising a signal controller configured for converting the digital TV signals into the readable TV signals, the readable TV signals comprising audio signals and video signals.

7. The digital TV as claimed in claim 1, further comprising a first Bluetooth earphone configured for reproducing sound corresponding the first analog audio signal from the first Bluetooth transmitter.

8. The digital TV as claimed in claim 1, further comprising a second Bluetooth earphone configured for reproducing sound corresponding the second analog audio signal from the second Bluetooth transmitter.
